(19) United States
(12) Patent Application Publication
(10) Pub. No.: US 2024/0054658 A1
(43) Pub. Date: Feb. 15, 2024

(54) TREADMILL SYSTEM AND KIT

(71) Applicant: Centigrade GmbH, Saarbruecken (DE)

(72) Inventors: Thomas IMMICH, Saarbruecken (DE); Frederic FRIESS-HERGENROEDER, Seeheim-Jungenheim (DE)

(21) Appl. No.: 18/350,514

(22) Filed: Jul. 11, 2023

(30) Foreign Application Priority Data
Aug. 10, 2022 (DE) 102022120173.2

(51) Int. Cl. G06T 7/246; G06T 7/73; A63B 24/00

(52) U.S. Cl. CPC G06T 7/246; G06T 7/73; A63B 24/0087; A63B 24/0062; G06T 2207/10016; G06T 2207/30204; G06T 2207/10048; G06T 2207/30196; A63B 2220/806; A63B 2220/05; A63B 2220/62; A63B 2220/31; A63B 2220/805

(57) ABSTRACT

The invention concerns a treadmill system (10), comprising a treadmill (20) having a treadmill surface (22) provided for treading on by a user (B), wherein optical markers (30, 32, 34) are formed on the treadmill surface (22), a camera device having at least one camera (42), wherein the camera device (40) is configured for acquiring a temporal image sequence comprising a plurality of images of at least a part (24) of the treadmill surface (22) while capturing the markers (30, 32, 34), and a control device (50) configured for receiving the image sequence from the camera device (40), determining, based on the image sequence, at least a movement information of the user (B) locomoting on the treadmill (20) while treading on the treadmill surface (22), and executing a control function based on the movement information. Furthermore, the invention concerns a kit for upgrading a treadmill (20).

The present invention concerns a treadmill system as well as a kit for upgrading a treadmill to a treadmill system.

Treadmills known from the prior art comprise a treadmill surface on which a user can run or walk or move by foot in a different way (perform locomotion) in the reference system of the treadmill surface. The treadmill surface may thereby be, for example, an outer surface of an endless belt, which is mounted by at least two deflection rollers to revolve such that the treadmill surface (in the reference system of the surrounding of the treadmill) at a running surface (upper side of the treadmill) treaded on by the user runs in a direction opposite to the running direction of the user. The locomotion speed (simplified “walking speed” or “running speed”) of the user thus essentially corresponds to the speed of the treadmill surface at the running surface.

An example for a treadmill is described in document EP 3 578 085 A1. This treadmill is positioned in the foot region of a workstation arrangement and is driven exclusively passively by the walking movement of the user. In order to achieve high profiling of the running surface, the running belt is formed by a plurality of wooden slats extending transversely to the running direction. The ends of the wooden slats are fastened to a left and a right guide belt, respectively, wherein the two guide belts in turn are supported circularly revolving on the left and the right side of the frame in order to reduce undesired noise development when the running belt is driven by the user.

In order to measure movement information about the user, for example a step number or a locomotion speed (moving speed), it is further known to use a mechanical sensor integrated into the treadmill or an external digital third-party device such as, for example, a fitness wristband or a smartwatch. These digital third-party devices are normally based on an acceleration sensor which interprets high peaks in the acceleration amplitudes as human step-changes.

Against this background, it is an object of the present invention to provide a relatively simple and cost-effectively producible treadmill system, which enables reliably and comfortably determining user-specific movement information. Furthermore, it is an object of the present invention to provide a corresponding kit.

This problem is solved by a treadmill system having the features of claim 1 as well as a kit according to claim 16.

The treadmill system comprises a treadmill having a treadmill surface (running belt surface, tread surface) provided for treading on by a user, wherein optical markers are formed on the treadmill surface, a camera device having at least a camera, wherein the camera device is configured for acquiring a temporal image sequence having a plurality of images of at least a part of the treadmill surface while capturing the markers, and a control device configured for receiving the image sequence from the camera device, determining, based on the image sequence, at least a movement information of the user locomoting on the treadmill while treading on the treadmill surface, and executing a control function based on the movement information. The control function may preferably be accompanied by outputting a control signal to a further component of the treadmill system.

This enables obtaining the movement information (i.e., one or more items of movement information) in an elegant manner in order to be able to reliably execute the control function of the control device. In particular, according to the invention, sensors carried by the user (for example, in third-party devices such as so-called wearables, e.g., in the form of fitness bracelets) can be dispensed with. Instead, the treadmill system by itself may be substantially autarkic as regards obtaining the movement information (for example a locomotion speed/movement speed (so-called walking or running speed) of the user). In this way, the comfort for the user may be increased. In addition, the treadmill system can be produced comparably easily and cost-efficiently. Furthermore, existing or prefabricated treadmills can be upgraded quite uncomplicated by the camera device and the control device, in order to obtain the movement information. In particular, no modification of the mechanics of the treadmill is required for said purpose.

The treadmill may generally be designed as a unidirectional or omnidirectional treadmill. Unidirectional treadmills are characterized in that the treadmill surface at the running surface is movable in a longitudinal direction parallel (and antiparallel for treadmills without return stop) to an axis (the so-called longitudinal axis of the treadmill). In omnidirectional treadmills on the other hand, the treadmill surface is movable at the running surface in a plurality of directions (two-dimensionally). In the context of this disclosure and in accordance with terminology in the field of treadmills, the running surface is the surface on the upper side of the treadmill provided for treading by the user during intended use. Thus, in the reference system of the surrounding of the treadmill, the running surface of the treadmill is stationary, in particular during use. On the other hand, the treadmill surface rotates in the reference system of the surrounding, wherein during this rotating a part of the treadmill surface forming the running surface changes continuously during the locomotion of the user. In the context of the present disclosure, the term “locomotion” (as well as locomotion speed, etc.) refers to locomotion (movement) of the user by foot, in particular, running, walking, sauntering, sneaking, hopping, etc., over the treadmill surface which moves opposite to the locomotion direction on the upper side of the treadmill.

The markers (markings) are preferably configured as infrared markers (“reflection markers”). They may be characterized in that they reflect (for the human eye invisible) infrared radiation (colloquially “infrared light”) better than the part of the treadmill surface surrounding the markers, i.e. that a contrast between the infrared markers and the background of the markers is for infrared radiation reflected at the treadmill surface greater than for visible light. In other words, the markers reflect infrared radiation (“infrared light”) more strongly than the part of the treadmill surface surrounding it, that is, a contrast results between the markers and the treadmill surface. Accordingly, the (at least one) camera is preferably configured as an infrared camera. In order to further improve said contrast during imaging by means of the camera device, the camera device may further comprise an infrared light which is arranged to irradiate at least the part of the treadmill surface. As a result, use of the treadmill, including relatively stable and correct measurement, may be enabled in various (preferably all conceivable) illumination situations, for example also in (theoretical) absolute darkness or daytime brightness. Furthermore, it is conceivable that the treadmill system may be designed in such a way that the complete treadmill/running belt reflects and the markers do not. This allows for better contrasting the feet by means of the same principle.

The treadmill surface may be an outer surface of an endless belt revolvingly mounted by at least two deflection rollers (pulleys). The endless belt may be designed as an elastic belt or have a plurality of elastic support belts which are deflected via the deflection rollers and on which the lamellae (slats) forming the treadmill surface are mounted. The markers may be integrated into the treadmill surface or, for example, be applied, e.g., be adhered, to the surface of the treadmill. In a variant explained in more detail below, the (plurality of) markers are provided together on a mat which is attachable to the treadmill. In the case of lamellae-based treadmills, the lamellae may also be provided with respective markers directly at the production of the treadmill. The markers preferably together form a pattern on the treadmill surface, which pattern is advantageously periodic in the longitudinal direction of the treadmill surface.

According to the pattern, the markers may be arranged in such a way that they form at least one first track, at least one second track, at least one third track, and optionally further tracks. In the context of the present disclosure, the term track refers to a linear (straight) arrangement of markers in a row. In other words, the totality of all optical markers provided on the treadmill surface is divided into a plurality of groups, each group forming one of the tracks described here, in which the associated markers are positioned in a row. The first track preferably extends parallel to the second track. If the treadmill is a unidirectional treadmill, the first track and the second track may extend in particular parallel to the longitudinal direction of the treadmill. If a plurality of first/second/third/further tracks are provided, they may be arranged next to one another when viewed from above, so that in a transverse direction a group having a first track, a second track and a third track is repeated in such a way that a further first track is arranged after the third track, and so on. In a further variant, two first tracks and two second tracks are arranged in a unidirectional treadmill in such a way that the first tracks are closer to a margin of the running surface than the second tracks when viewed from above.

The markers of the first track (hereinafter first markers), the second track (hereinafter also second markers) and any further tracks (in particular, the third track, in the following: third markers) are arranged periodically on the treadmill surface, respectively. That is to say, within the respective track, a period ((longitudinal) offset, so-called pitch, between the markers) is preferably constant. It follows that scanning the treadmill surface along a scan line extending transverse to the direction of locomotion/travel (at a fixed locomotion/travel speed), a periodic signal may result, too. In a preferred variant, the markers of the first track (first markers) are arranged closer to one another than the markers of the second track (second markers). Accordingly, a period in a first intensity signal corresponding to the first track may be smaller than a period of a second intensity signal corresponding to the second track. The period may double from track to track; for example, the period in the second track may be twice as large as the period in the first track and/or the period in the third/further track may be twice as large as the period in the second track.

In addition, the first markers may be designed (optically) differently than the second markers. The first markers may differ, in particular, with respect to their geometry (for example, their number of corners), their size and/or their reflection spectrum from the second markers. For example, the first markers may be circular, the second markers may be quadrangular and the further/third markers may be triangular. This enables recognizing the tracks comparably easily by means of the camera device and distinguishing them from one another.

If the markers are arranged such that they further form the third track, it is preferably provided that the third track extends transversely to the first and/or second track. Furthermore, a fourth track extending parallel to the third track may be formed. Preferably, (apart from the orientation) the third track is configured like the first track and/or the fourth track is configured like the second track. This pattern of markers is particularly suitable for omnidirectional treadmills, wherein the user may change the running direction over time, and, thus, may temporarily run along the first/second or third/fourth track.

A single-colored (for example, gray or black) central strip is preferably formed on the treadmill surface, wherein the strip preferably extends in a longitudinal direction of the (preferably unidirectional) treadmill. The central strip may be configured as a continuous (“coherent”) infrared reflecting surface. The central strip is preferably wider than the first, second, third, and/or fourth track. Thus, the area of the treadmill surface on which the user may advantageously place his feet may be comparably wide. As a result, the user may place his feet more freely on the treadmill. The first, second, third or fourth track, respectively, are preferably used exclusively for speed measurement, while the central strip is used exclusively for position detection. The central strip may correspondingly at least temporarily assume at least 80% or at least 90% of the width of the running surface. Preferably, the central strip has a width perpendicular to the longitudinal direction, which is at least 10 cm or at least 20 cm. Preferably, the first, second, third, and fourth tracks, respectively, run between the strip and a lateral margin of the running surface. The strip is configured for forming a uniform background for the foot of the user. This makes it possible to precisely detect not only the markers but also the foot contour of the user. In the following, the term “the tracks” refers to the first, second, third, and, if applicable, further tracks. Analogously, the term “the markers” refers to the first, second, third, and, if applicable, further markers.

Furthermore, the markers may comprise a plurality of, preferably at least 4, differently configured reference markers which are arranged at corners of an imaginary polygon, in particular rectangle, on the treadmill surface. The reference markers preferably differ optically from one another in such a way that they are all reproduced differently in the images. That is, all reference markers may be different with respect to predetermined optical properties. For this purpose, each reference marker may have a pattern characteristic for that reference marker. The patterns may be binary, for example, as bar codes, QR codes or ArUco markers. An ArUco-marker is a synthetic square marker consisting of a black border and an inner black-white (binary) pattern (so-called binary matrix) surrounded by the border, the pattern defining the identifier of the marker. The reference markers may be distributed on tracks of equal periods (e.g., two first tracks or two second tracks). Preferably, the reference markers differ from the other markers provided in the respective tracks. Most preferably all markers, including the reference markers located there, have the same contour in the respective track. This enables using the reference markers for image correction without disturbing with the determining of the movement information. Furthermore, the reference markers are preferably of the same size.

The reference markers are provided to be used by the camera device in order to subject the (preferably all) images of the temporal image sequence to be obtained by the control device to an image correction. The image correction preferably contains a (perspective) equalization (so-called keystone or trapezoidal correction). In this way, the camera may be arranged close to the ground, in particular at a vertical distance of less than 80 cm or less than 50 cm from the running surface of the treadmill, at a longitudinal end of the treadmill, and preferably be oriented flat to the treadmill surface. An intermediate angle between the optical axis of the camera and the treadmill surface may preferably be less than 60° or less than 45° or less than 30°. Accordingly, the camera device may be integrated on the treadmill restrained and, in particular, below the eye height and/or above the step height of the user.

In order to execute the perspective equalization, the camera device may acquire, preferably separately from and/or chronologically before the acquisition of the temporal image sequence, at least one separate image provided for the calibration. This may be carried out in an initialization process of the camera device. If, for example, the camera is arranged as explained above, the running surface may have a trapezoidal shape on the separate image (in particular a true trapezoidal shape with exactly two parallels and two edges running obliquely thereto and with respect to one another), wherein the treadmill is imaged on the separate image wider at the top than at the bottom. Accordingly, the tracks on the separate image may not run vertically, but (in the course from bottom to top) run obliquely outwards, wherein the recognition of the marking is advantageously not adversely affected thereby.

In order to perform the equalization, the camera device may obtain information about the actual arrangement of the reference markers (which are suitably stored in the treadmill system). For example, this information may contain a target arrangement of the reference markers on an image to be captured after calibration. This target arrangement may correspond to an arrangement of the reference markers in reality (on the treadmill surface; in vertical view). In the case of the imaginary polygon, the reference markers may thus be arranged at the corners of the polygon in the target arrangement. From the captured, separate image, the camera device may further determine the actual arrangement of the reference markers in the separate image. The camera device may derive from a difference (discrepancy) between the actual arrangement and the target arrangement a correction function which is suitable for converting the actual arrangement to the target arrangement. Furthermore, the camera device may store this correction function in order to apply it later, when acquiring the temporal image sequence, to captured image data. Thus, the acquisition of the temporal image sequence may include subjecting the captured (uncorrected) image data to the correction function, so that the images of the temporal image sequence may be subjected to the image correction, in particular may be perspectively rectified (for example, trapezoidally corrected) by means of the camera device on the basis of the reference markers. Therefore, manufacturing tolerances are not critical for the function of the treadmill system.

It has been said that the control device is configured to determine the (item(s) of) movement information of the user based on the image sequence. The movement information may be determined directly (i.e., on the basis of a detected body part of the user, preferably of the foot) or indirectly (in particular by means a movement parameter of the treadmill). The motion information may include a locomotion speed (movement/travel speed) of the user on the treadmill surface (relative to the moving treadmill surface, not relative to the surrounding of the treadmill), an acceleration of the user, a position and/or a time of a tread by the user on the treadmill surface, an orientation of a foot of the user at the time of the tread and/or a shape of the foot of the user at the time of the tread. The term “foot of the user” refers here to the user foot naked or (for example, wearing footwear). In this respect, any clothing of the user is to be regarded as part of the user.

In the following, various variants will be discussed, each having respective parts of the control device provided for determining (one item of) movement information. For the sake of clarity, these parts are designated by own names (speed determining device, tread determining device, foot orientation detection device, etc.), albeit they do not necessarily have to be configured as enclosed components of the control device. Rather, the parts of the control device are to be understood logically.

In a preferred variant, the control device determines the locomotion speed of the user as part of the movement information on the basis of the temporal image sequence by using the markers. For this purpose, the control device has the speed determining device, which is configured for determining, from the sequence of image, one or more temporal intensity profiles at a predetermined location in the plurality of images (via the image sequence). Thereby, the treadmill surface is essentially being optically scanned while detecting the pattern formed by the markers in the tracks in order to determine the intensity profiles, and the locomotion speed is determined on the basis of the intensity profiles.

In detail, the speed determining device receives the temporal image sequence with the plurality of (preferably trapezoidal-corrected) images (directly or indirectly) from the camera device. The images of this image sequence may first optionally be converted by the speed determining device to edge images by means of an edge detection filter (for example, a Sobel filter). In this case, what is stated below for the images applies, mutatis mutandis, to the edge images. The images of the image sequence are then preferably evaluated in order to determine the intensity profiles. For this purpose, objects corresponding to the markers are recognized in the images by means of the speed determining device. The recognition of these objects may advantageously be performed by means of pattern matching. For this purpose, the optical shape of all the markers (i.e., the individual markers) provided on the treadmill surface and/or the pattern formed by the markers in the tracks on the treadmill surface may be stored in the treadmill system and taken into consideration for the pattern matching. In the example mentioned above, the circles of the first track, the rectangles of the second track and/or the triangles of the third track may thus be recognized in the images. It should be emphasized, however, that different geometric shapes of the markers are not absolutely necessary. For example, markers of the first/second/third tracks may be rectangular. The intensity profile or period of rectangular areas is sufficient for precise determining of speed.

The speed determining device may then determine an associated intensity profile per track. For this purpose, the speed determining device preferably uses a sampling rate of the camera in order to determine a time offset between the images of the image sequence, on the basis of which a time value (in a diagram: the x value) is determined for each data point of the intensity profile. The associated intensity value (y value) may result for each of the images from the associated value of the pixel at a location (position in the respective image with fixed image coordinates (a, b)) on the respective track. Since all the images may be evaluated at the same point, a temporally periodically variable intensity may thus be determined as a result of the circulating movement of the treadmill, said intensity being characteristic of the speed of the treadmill surface in the region of the running surface, which corresponds to the locomotion speed of the user.

The speed determining device may be configured for converting the intensity profile into the locomotion speed of the user on the basis of conversion information available to it. For this purpose, the speed determining device may, for example, determine a period in the periodic intensity profile and convert it into the locomotion speed of the treadmill surface or the locomotion speed by means of the conversion information. The latter may then be used as part of the movement information in the treadmill system.

In a preferred variant, the speed determining device is configured for changing between the tracks to be used for determining the locomotion speed as in dependence of the determined locomotion speed of the user. In this variant, the locomotion speed is preferably first determined on the basis of the first track (in which an offset between the markers is lowest). The speed determining device is further configured for determining whether the locomotion speed determined in this way exceeds a predetermined first threshold value (if, for example, the user accelerates and transitions to running). If this is the case, i.e. from exceeding the first threshold value, the speed determining device may use the farther spaced second markers (of the second track) for determining the locomotion speed as explained above. From a second threshold value, the speed determining device may then be configured for executing the determining of the locomotion speed on the basis of the third markers/third track, and so on. Conversely, at a deceleration of the locomotion speed of the user and going below the first threshold, the speed determining device may return from use of the second track to using the first track. As a result, a comparably large bandwidth of speeds may be precisely determined by means of a relatively inexpensive camera without particularly high sampling rates and/or resolutions.

In particular, but not only, if the control device has the tread determining device and/or the foot orientation detection device, the control device may be configured to determine an image object having the largest area and/or contour in at least a first image, a second image and a third image of the plurality of images of the temporal image sequence. This image object representative for the foot may form the basis for the further function of the tread determining device and the foot orientation detection device (as a foot image object corresponding to a foot of the user). For this purpose, it may be provided that the camera is arranged in such a way that its detection region does not project beyond the treadmill surface.

The tread determining device is preferably provided for ascertaining a tread of the user with his foot on the treadmill surface at the end of a step performed by the user (in brief: tread of the foot). In this respect, the tread determining device may be configured as a step counter. In this case, too, the images of the image sequence, as in the case of the speed determining device, may first optionally be converted into edge images by means of an edge detection filter (for example a Sobel filter), wherein the statements made hereinafter for the images applies correspondingly for the edge images. For determining the tread, the tread determining device is preferably configured such as to determine a first movement direction of the foot of the user on the basis of a first position of the image object representative for the foot in the first image and a second position of the image object in the second image. For this purpose, for example, first coordinates of a reference point (for example, a center of mass or a point in the region of a predetermined toe) of the image object in the first image and the second coordinates of the reference point (for example, the center of mass or point in the region of the predetermined toe) of the image object in the second image may be determined and a movement vector from the first coordinates to the second coordinates may be determined. A direction of this motion vector may be defined as the first movement direction. Analogously thereto, on the basis of the second position of the image object in the second image and a third position of the image object in the third image, a second movement direction of the foot of the user may be determined by means of the tread determining device.

The tread during the locomotion/movement over the treadmill may advantageously be detected in a simple, elegant and reliable manner camera-based, because it is accompanied by a direction change of the image object. In said arrangement of the camera, the image object (in the image sequence), namely moves successively downwards before the tread, and upwards after the tread (and vice versa). Accordingly, the tread determining device is therefore preferably configured for determining whether an angle between the first movement direction and the second movement direction exceeds a predetermined angle threshold value. If this is not the case, the function of the tread determining device restarts as in a loop. If, on the other hand, the angle exceeds the predetermined angle threshold value, the tread determining device ascertains the tread of the user on the treadmill surface and preferably stores the position of the image object in the second image and/or the time of the tread. Accordingly, the movement information on which the control function to be executed is based may preferably contain the position of the image object in the second image, a position of the tread which is derived therefrom on the treadmill surface and/or the time point of the tread.

According to a further variant, in which the control device comprises the foot orientation detection device, the tread of the foot on the treadmill surface is determined as explained above. In this case, at least one parameter specific to the gait of the user, in particular the foot orientation at the tread, may be determined on the basis of the associated second image. Thereby, too, the images of the image sequence, as in the case of the speed determining device, may initially optionally be converted into edge images by means of an edge detection filter (for example a Sobel filter), wherein the statements made in the following for the images applies for the edge images, correspondingly.

In detail, the foot orientation detection device is configured for determining, in the second image, a minimum bounding polygon, in particular a minimum bounding rectangle, for the image object and a main extension direction of the minimum bounding polygon/rectangle. In the context of this disclosure, the minimum bounding polygon/rectangle is that polygon/rectangle with the smallest area which encloses the image object. The main extension direction advantageously runs parallel to the longest side of the polygon and to a longitudinal side of the rectangle, respectively. Furthermore, an angle of tread between this main extension direction/longitudinal side and the longitudinal direction of the imaged tracks/the longitudinal direction of the running surface, which is representative of the foot orientation, may be determined from the second image. The foot orientation detection device is accordingly configured for enabling the movement information to contain the main extension direction and/or the mentioned tread angle.

A further variant provides that the control device has a user recognition device (for identifying the user). The user recognition device may be configured to identify the user based on a contour of the image object. For this purpose, a plurality of contour patterns, each specific to a user, may be stored in the control device. The user recognition device may determine by means of pattern recognition whether the contour of the image object corresponds to one of these contour patterns. If this is the case, the user recognition device may be configured for setting a user identity (“user ID”) as part of the movement information. Different footwear may be considered as different profiles of the recognized user. If the contour of the image object corresponds, for example, to a contour pattern corresponding to a naked foot (“barefoot”), the control function may contain one or more Yoga applications on the display device. If the contour of the image object corresponds, for example, to a contour pattern corresponding to a sports shoe (“sneaker”), the control function may contain displaying one or more running applications (“running apps”) on the display device.

The treadmill system preferably further comprises a display device for displaying the movement information to the user. In this case, the control device may be configured for controlling the display device accordingly. What is said in the following for the display images applies, mutatis mutandis, to each display image. That is to say, the control function preferably comprises controlling the display device to display the movement information in one or more display images. In addition, the treadmill system may have a memory unit. Accordingly, the control function may comprise controlling the memory unit to store the movement information. In addition, the treadmill system may have a data transmission device. The control function may comprise controlling the data transmission device to send the movement information to a third-party device.

The display device may have a projection device which is arranged to project the movement information in the display image(s) onto the treadmill surface, in particular, onto the part of the treadmill surface of which the images have been acquired. The detection region of the camera may be registered, in particular congruent or concentrically and aligned, with a projection area (surface) of the projection device on the treadmill surface. This enables displaying the at least one determined movement information in a simple manner intuitively the user, in particular as a number or graphic. In particular, if the camera is an infrared camera, the camera may be provided with an optical filter attenuating (damping) visible light and arranged on an optical axis of the camera. The optical filter may thus be more transmissive for infrared light than for visible light. The image sequence is preferably detected by means of the camera through the optical filter. In this way, a disturbance of the camera device by (projection) light of the display device may be effectively reduced or prevented.

The control function may preferably contain forming the display images, respectively, as follows. If the movement information contains the locomotion speed of the user, the control function may contain moving a visual representation displayed by the display images, for example a virtual running environment with obstacles on the ground, according to the locomotion speed over the projection area. The movement of the virtual running environment may preferably be designed in such a way that parts of this running environment are stationary in the reference system of the (moved) treadmill surface. In this way, an immersive experience may be imparted to the user.

If the movement information contains the main extension direction of the minimum bounding polygon/rectangle, this main extension direction may be used to control a movement direction through the virtual running environment. This is advantageous, in particular, in the case of omnidirectional treadmills for an immersive experience of the user. If the tread determining device is provided, the display images may contain the image object (or a graphic representative of the image object, e.g., a schematic footprint) at the same position as in the second image and/or further information regarding the derived position of the tread on the treadmill surface and/or the time point of the tread. In addition, combinatorial graphic elements may be represented in the display images. For example, these graphic elements may be represented in a situation when there is a collision between the image object and an object from the virtual running environment (e.g., the obstacle).

In a further variant, the display device may comprise goggles for virtual or augmented reality (VR glasses or AR glasses). In this case, the display images may be displayed in the goggles. What has been said above for the display images therefore applies accordingly. The individual devices may then act together as a standard XR input device, so that existing VR contents may also be controlled via this standard interface.

In particular, if the treadmill is designed as a lamellae-based treadmill with the lamellae running transversely over the running surface, the markers may be, instead of directly on the lamellae, part of a mat which is provided by means of a mounting device, by means of which the mat may be fastened non-destructively reversibly to the lamellae of the treadmill. The mat may be designed elastically and/or as a floor mat. Furthermore, the mat may be produced, partially or completely, from a rubber (in particular, caoutchouc), from a plastic knitted fabric (in particular, a polyester knitted fabric) and/or a textile (in particular, as a carpet). The mat may be coated with a foam (in particular a soft foam). The mat may be configured, for example, as a yoga mat. The treadmill surface may be designed as surface of the mat. The mounting device may have one or more profile strips (angled strips), which may each preferably extend from the mat between two mutually adjacent lamellae and bear against the mat on a side opposite the mat.

Since a distance between the lamellae may change during deflection over the deflection rollers, a section of the mat between two adjacent profile strips is preferably provided with a fold, while this section of the mat is arranged on the running surface. The fold is dimensioned in such a way that it is smooth-pulled during the deflection of said section over the deflection rollers and re-forms in the region of the running surface. In order to increase the comfort of the user, the fold may be provided with a magnet device which reduces a height of the fold perpendicular to the running surface.

On the basis of the variant with the mat, a herein proposed kit for upgrading a treadmill to a treadmill system described in detail above may comprise the camera device, the control device, and the mat having the mounting device. The control device and the camera device may be provided in a common housing, which may be put at a longitudinal end of the treadmill or attached to the treadmill at the upgrading. Due to the reference markers, additional trapezoidal-correcting manual calibration can be dispensed with. The mat may in turn be attached to the lamellae by means of the mounting device.

The kit may further comprise any, in particular all, features of the treadmill system described in detail above.

Moreover, a further treadmill system is presently disclosed in independent form, which further treadmill system comprises: a treadmill having a treadmill surface provided for treading on by a user, a camera device having at least a camera, wherein the camera device is configured as infrared camera and is configured for acquiring a temporal image sequence having a plurality of images of at least a part of the treadmill surface while capturing the markers, and a control device, which is configured for receiving the image sequence from the camera device, determining, based on the image sequence, at least a movement information of the user locomoting on the treadmill while treading on the treadmill surface, and executing a control function based on the movement information.

This further treadmill system may further include all features of the treadmill system described above in detail. In particular, this further treadmill system may contain the tread determining device, the foot orientation detection device, the user recognition device and/or the display device.

Preferred embodiments of a treadmill system will now be explained in greater detail with reference to the accompanying schematic drawings, not true to scale, wherein

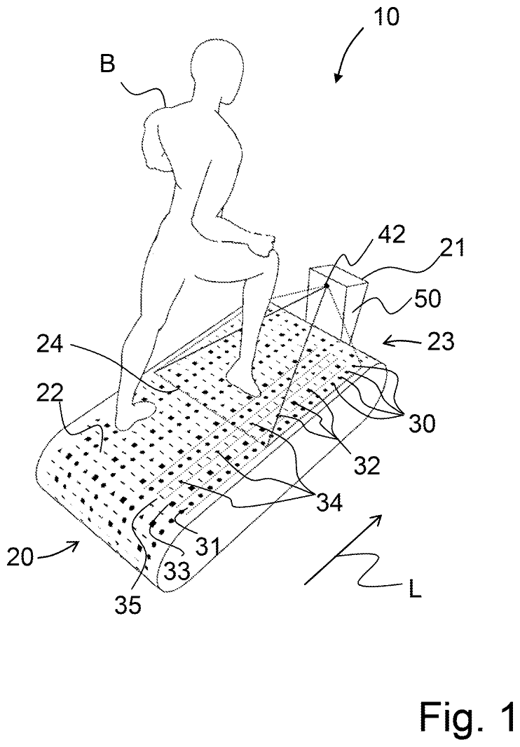

FIG. 1 shows a first variant of a treadmill system in a perspective overall view, wherein determined movement information is stored in the control device;

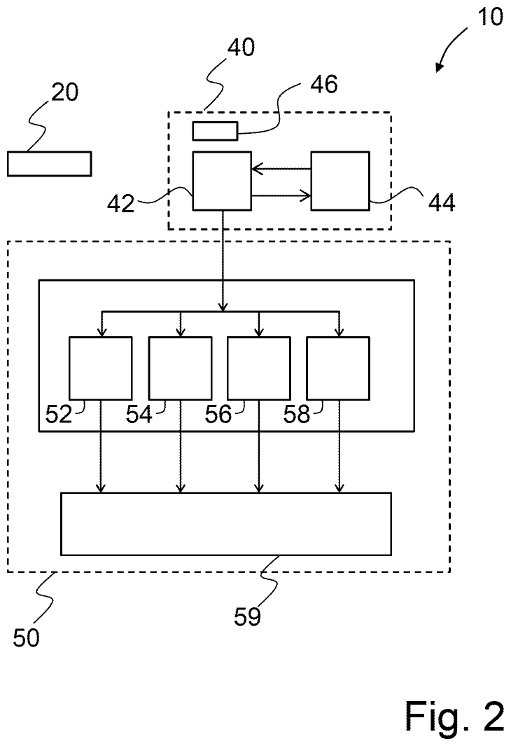

FIG. 2 shows the treadmill system of FIG. 1 in a schematic detail view with its components;

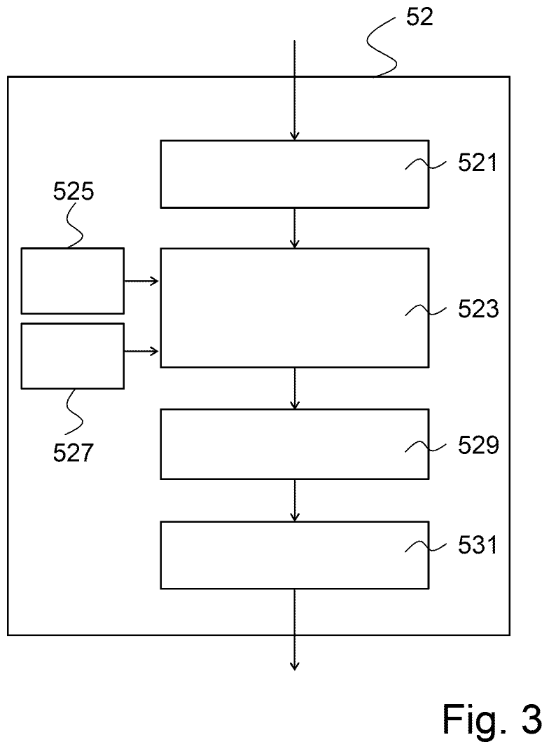

FIG. 3 shows the mode of operation of a speed determining device of the treadmill system of FIG. 1 in a simplified manner;

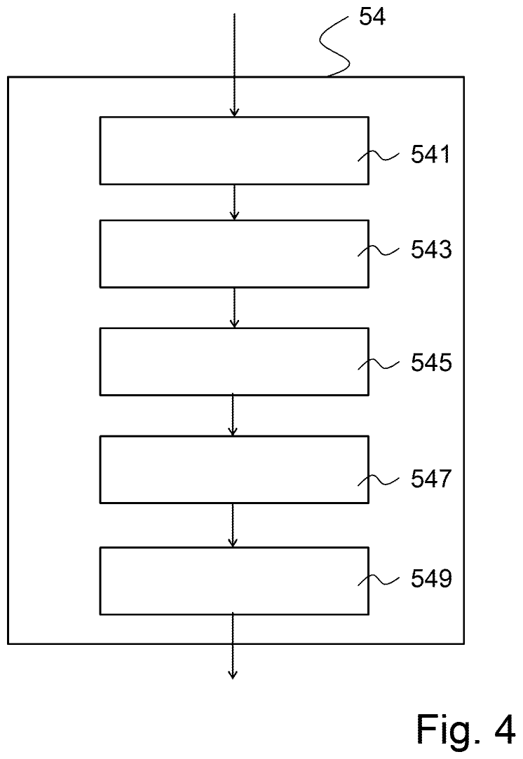

FIG. 4 shows the mode of operation of a tread determining device of the treadmill system of FIG. 1 in a simplified manner;

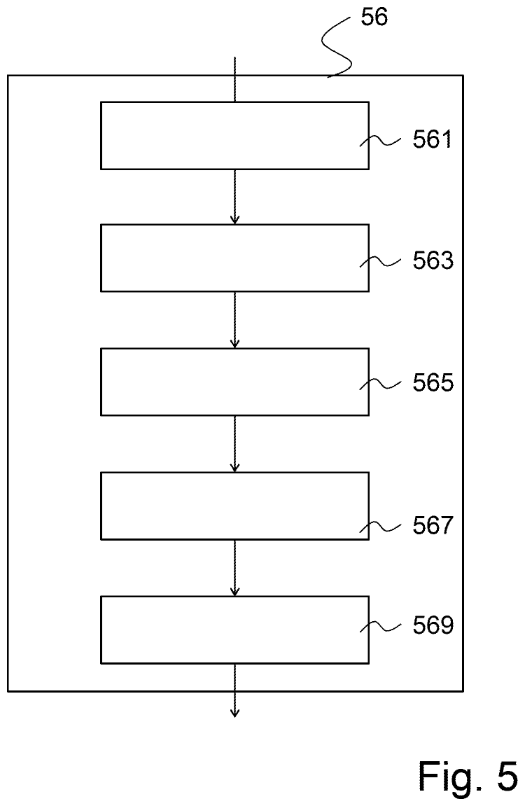

FIG. 5 shows the mode of operation of a foot orientation detection device of the treadmill system of FIG. 1 in a simplified manner;

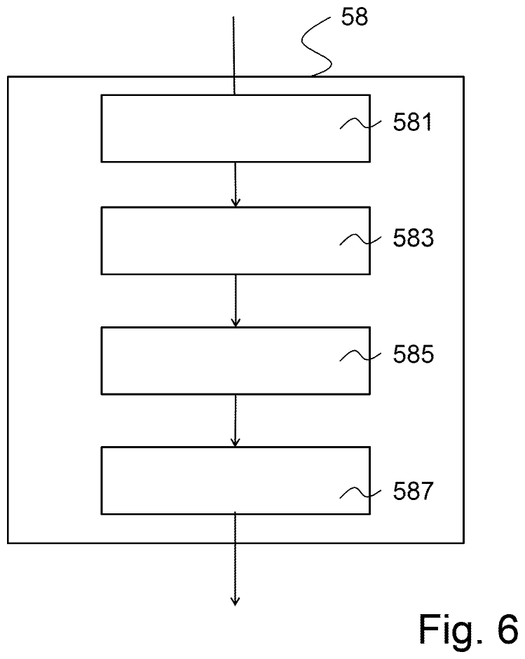

FIG. 6 shows the mode of operation of a user recognition device of the treadmill system of FIG. 1 in a simplified manner;

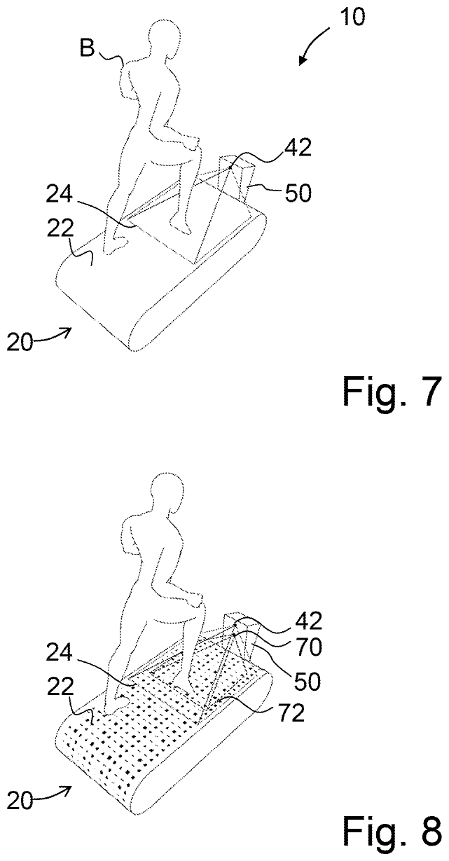

FIG. 7 shows a further variant of a treadmill system in a perspective overall view which does not have the speed determining device;

FIG. 8 shows a further variant of a treadmill system in a perspective overall view, wherein a display device with a projection device is additionally provided;

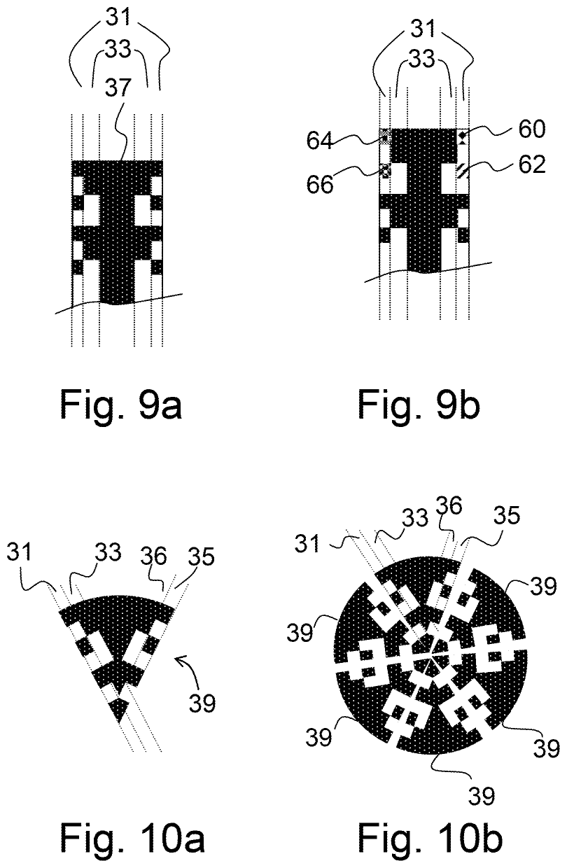

FIG. 9a shows a treadmill surface of the treadmill system of FIG. 8 in a detailed view;

FIG. 9b shows a modification of the treadmill surface of the treadmill system of FIG. 8 in a detailed view;

FIG. 10a shows a treadmill surface of a further variant of a treadmill system with an omnidirectional treadmill in a detailed view;

FIG. 10b shows a treadmill surface of a further variant of a treadmill system with an omnidirectional treadmill in a detailed view;

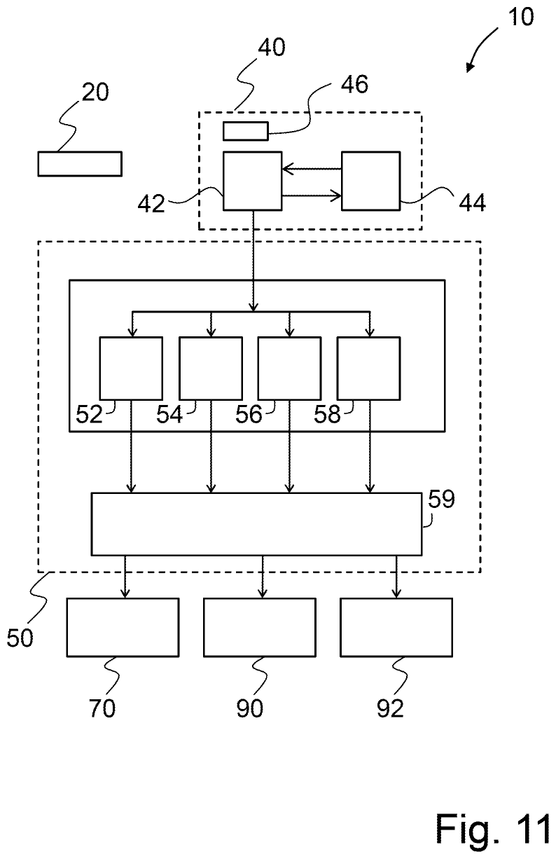

FIG. 11 shows the treadmill system of FIG. 8 in a schematic detail view with its components;

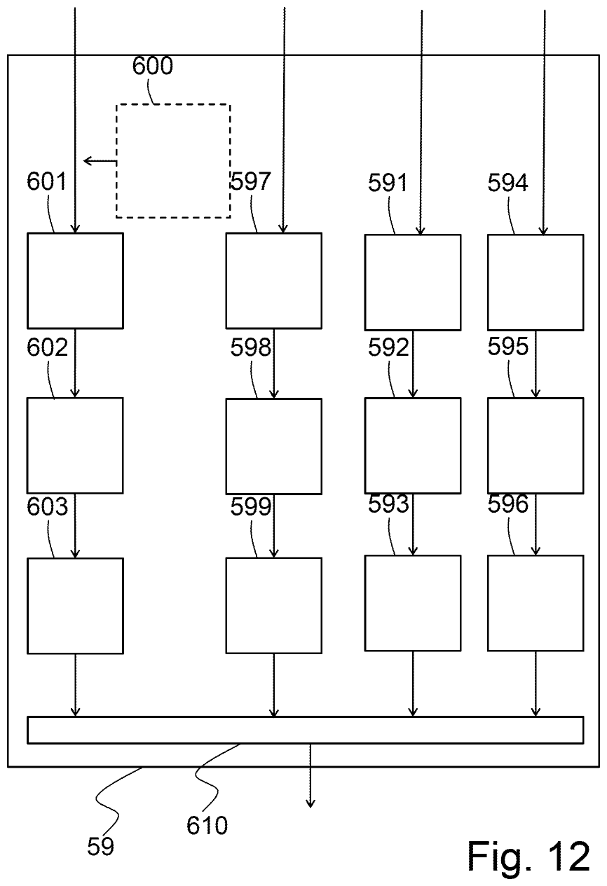

FIG. 12 shows the mode of operation of a control device of the treadmill system of FIG. 8 for executing a control function in a simplified manner;

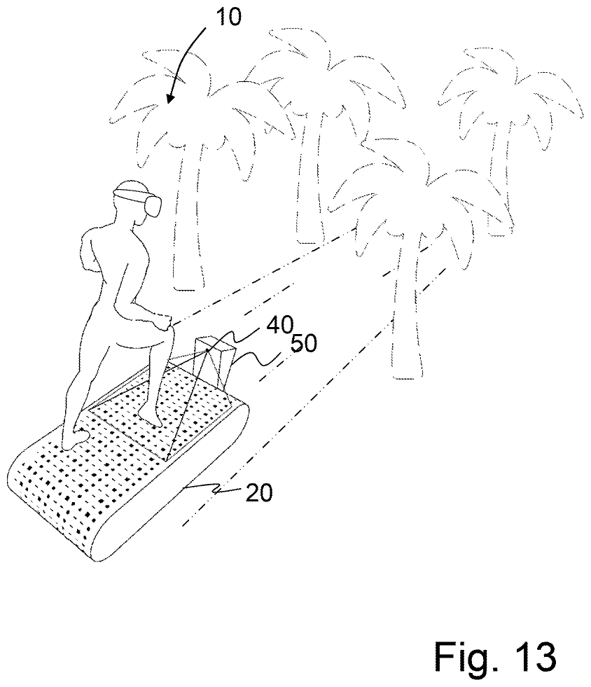

FIG. 13 shows a further variant of a treadmill system in a perspective overall view, in which the display device is designed with VR glasses;

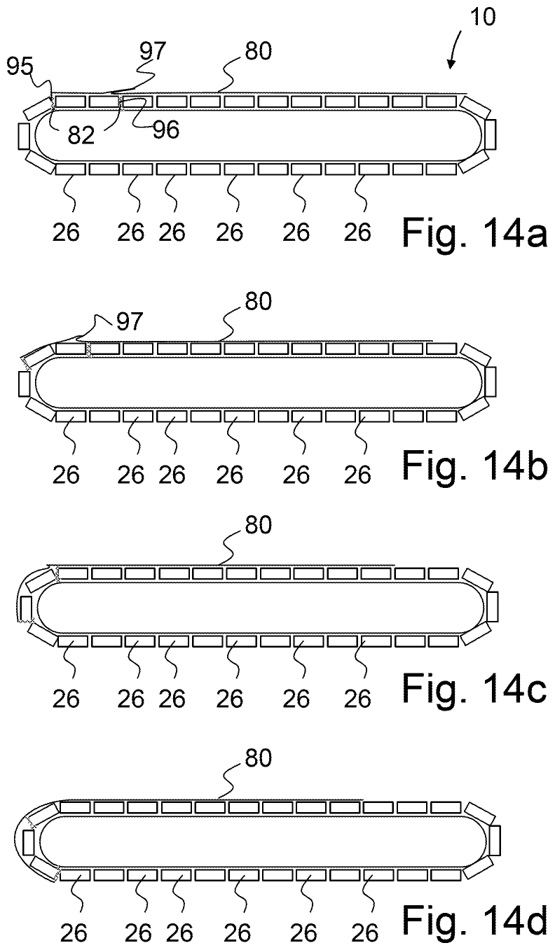

FIGS. 14a-14d show a treadmill according to a further variant of a treadmill system in a cross-sectional view, wherein a treadmill surface is formed as a surface of a mat; and

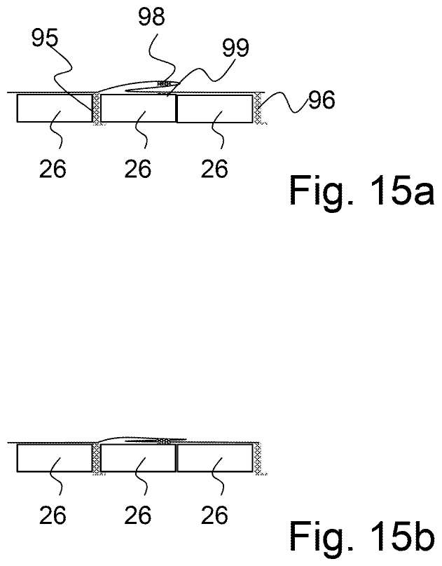

FIGS. 15a-15b show a section of the treadmill of FIG. 14a in a cross-sectional view showing a fold in the mat.

FIGS. 1 to 6 show a treadmill system 10 with a treadmill 20, as well as a camera device 40 and a control device 50, wherein the camera device 40 and the control device 50 in this variant are arranged in a common housing 21 centered on the longitudinal front end 23 of the treadmill 20. Thereby, the housing 21 may in principle be standing mechanically decoupled from the treadmill 20 on the ground. The control device 50 may be configured, for example, as a computer with a motherboard and processor and may be connected to the camera device 40 in a signal-transmitting manner.

The treadmill 20 is a unidirectional, passively driven treadmill 20 having a longitudinal direction L. It comprises an endless belt arranged for revolving, which is deflected via deflection rollers (not shown) arranged at the front and rear in the longitudinal direction L. The endless belt forms a treadmill surface 22 provided for treading on by the user B. That is to say, the treadmill surface 22 is that surface of the treadmill 20 onto which the user B treads and which moves under the user B in the reference system of the surrounding of the treadmill 20.

Optical markers, comprising first markers 30, second markers 32 and third markers 34, are formed on the treadmill surface 22. The first markers 30, second markers 32, third markers 34 and, if applicable, all remaining markers of this treadmill 20 are configured as infrared markers which reflect infrared radiation and/or visible light. The infrared radiation may preferably be reflected better/more intense than visible light. Alternatively, (commercially available) reflective adhesive tape may be used which reflects both visible and invisible light (for example, similarly or equally strong). In the present variant, the infrared markers may have a higher reflectivity in at least part of the infrared portion of the electromagnetic spectrum (from 690 nm) than in the visible portion of the electromagnetic spectrum. The camera device 40 is accordingly configured with at least a camera 42, wherein the camera 42 is an infrared camera (optionally a thermal imaging camera). The infrared camera may be configured for detecting near infrared radiation (NIR), mid-infrared radiation (MIR) and/or radiation of the far infrared spectrum (FIR). The camera device 40 is configured for acquiring a temporal image sequence having a plurality of images of at least one part 24 of the treadmill surface 22 while capturing the first markers 30, second markers 32 and third markers 34 by means of the camera 42. In addition, the camera device 40 comprises an infrared light 46 having at least one infrared light source which is arranged to irradiate at least the part 24 of the treadmill surface 22.

The first markers 30 are arranged in a first row extending parallel to the longitudinal direction L, said first row being referred to as the first track 31 and extending in a straight line. The second markers 32 are arranged in a second row extending parallel to the longitudinal direction L, said second row being referred to as the second track 33 and likewise extending in a straight line. The third markers 34 are arranged in a third row extending parallel to the longitudinal direction L, said third row being referred to as the third track 35 and likewise extending in a straight line. Altogether, a plurality of first tracks 31, second tracks 33 and/or third tracks 35 may be formed on the treadmill surface 22. In the variant of FIG. 1, in a transverse direction (perpendicular to the longitudinal direction L), starting in the running direction on the right side, a first track 31, then a second track 33, a third track 35, then again a first track 31, a second track 33 and a third track 35, etc., are provided. The statements made hereinafter for the first track 31, the second track 33 and the third track 35, respectively, apply correspondingly to each first, second or third track 31, 33, 35. The first markers 30, second markers 32, and third markers 34 have different shapes, for example a circular shape, a rectangular shape, and a triangular shape, respectively.

In the first track 31, the first markers 32 of the longitudinal direction L are arranged periodically with the same first offset (so-called longitudinal offset, “pitch”) between adjacent first markers 32. Since all the first markers 32 are substantially equally sized, a distance between adjacent first markers 32 in the first track 31 is also the same everywhere in the first track 31. This applies, mutatis mutandis, to the second track 33 and the third track 35. I.e., in the second track 33 and the third track 35, the second and third markers 32, 34 are respectively arranged periodically in the longitudinal direction L with the same second/third offset between adjacent first markers 32. Advantageously, the second offset is greater than, in particular twice as large as, the first offset. The third offset between the third markers 34 is in turn greater than, in particular twice as large as, the second offset. This allows precise speed determining over a relatively large speed range with a relatively simple camera 42. For the sake of completeness, it should be noted that, in FIG. 1 between markers of the second and third tracks 33, 35, place holders in the form of bars are shown, which, however, serve only for the graphic representation and which do not have any function during the evaluation. The different geometric shapes (triangle vs. circle vs. square) do not necessarily have to be applied; rather, uniform (for example rectangular) markers also suffice.

The temporal image sequence acquired by the camera device 40 is then processed by means of the control device 50 such that, on the basis of the image sequence, at least a movement information of the user B locomoting (moving) on the treadmill 20 is determined on the basis of the image sequence. As explained below, a control function may then be executed on the basis of the (item(s) of) movement information. In the variant of FIG. 1, a plurality of items of user information are determined, namely (by means of a speed determining device 52) a locomotion speed of the user B, which corresponds to a movement speed of the treadmill surface, (by means of a tread determining device 54) a position and a time of a tread of the user B on the treadmill surface 22, (by means of a foot orientation detection device 56) an orientation of a foot of the user B at the time of the tread and (by means of a user recognition device 58) a user identity.

The mode of operation of the speed determining device 52 of the control device 50 is shown in FIG. 3 as a block diagram. The mode of operation is designed in such a way that at least one temporal (reflection) intensity profile is determined from the image sequence at a predetermined location on the running surface, scanned by the plurality of images, and the locomotion speed of the user B is determined as part of the movement information on the basis of the at least one intensity profile. Each of these images of the image sequence may already be perspectively equalized (trapezoidal corrected) by means of the camera device 40.

In a block 521, the images of the image sequence are converted into edge images by means of edge detection and the contours of image objects corresponding to the markers are selected. By means of subsequent pattern matching (block 523) on the basis of patterns stored in the control device 50 (block 525) of the first, second and third markers 30, 32, 34 and/or information about the first, second and third offset (block 527), the first, second and third markers 30, 32 and 34 (respectively, their associated image objects) may be recognized in the images.

The actual calculation of the locomotion speed is then carried out in block 529. For this purpose, for each of the first, second and third tracks 31, 33, 35, an associated temporal intensity profile may be determined from the image sequence. Thereby, a course of the image value over time is determined at a predetermined point (image pixel defined by its x and y coordinates in the respective image) per track. The time component may be determined via software or clocking of a processor of the control device 50 or alternatively from a sampling rate of the camera 42. As a result, for example, an intensity profile for the first track 31 is characterized by separate local maxima (peaks), which are the farther spaced from each other, the lower the locomotion speed is. This applies, mutatis mutandis, to the second track 33 and the third track 35.

Alternatively, black and white images may be generated in blocks 521 to 529 from the images of the image sequence by means of threshold value operations and a binary conversion, from which images the markers stand out. Speed information is calculated based on the pixel values in determined regions and the elapsed time between two images. In this case, no pattern matching is required.

The speed determining device 52 is advantageously configured for using the first track 31 for determining comparably low locomotion speeds and the third track 35 for determining higher locomotion speeds. The second track 33 is preferably used for determining locomotion speeds in a range of values between the low locomotion speeds and the high locomotion speeds. In particular, the speed determining device may be configured for determining the locomotion speeds of the user on the basis of the first track 31, starting at the standstill of the treadmill. As soon as this determined locomotion speed exceeds a predetermined first threshold value (for example, 1 m/s or 2 m/s), the speed determining device 52 may be configured to determine the locomotion speed on the basis of the second track 33. If the determined locomotion speed exceeds a further predetermined, second threshold value (for example 3 m/s or 5 m/s) which is greater than the first threshold value, i.e. the user B thus e.g. begins to run, the speed determining device 52 may be configured to determine the locomotion speed on the basis of the third track 35. When reducing the locomotion speeds below the second/first threshold value, the speed determining device 52 may respectively be configured for returning to determining the locomotion speeds on the basis of the second track 33 and first track 31, respectively. This enables precise speed determining using cost-effective technical means. The determined locomotion speed may be used in each case in block 531 for executing the control function.

The mode of operation of the tread determining device 54 of the control device 50 is shown in FIG. 4 as a block diagram. Hereby, as well as in the case of the foot-orientation detection device 56 and the user recognition device 58 explained below, the images of the image sequence may already be perspectively equalized (trapezoidal-corrected) by means of the camera device 40. In a block 541, the images of the image sequence are converted analogously to block 521 by means of edge detection into edge images and the contours of image objects corresponding to the markers are selected. Block 543 then provides for determining an image object having the largest area and/or contour, in at least a first image, a second image and a third image of the plurality of images (edge images). If, namely, the detection range of the camera 42 is restricted to the part 24 of the treadmill surface 22, that is to say only the treadmill surface 22 is detected, it may be assumed that this image object is a (clothed or unclothed) foot of the user B.

In block 545, a first movement direction of the foot of the user B is then determined on the basis of a first position of the image object in the first image and a second position of the image object in the second image. Before the tread, this movement direction is directed longitudinally forward in the direction L towards the camera 42. In the image sequence, this movement is represented as a displacement of the image object in the downward direction. In the same block, a second movement direction of the foot of the user B is further determined on the basis of the second position of the image object in the second image and a third position of the image object in the third image. If the second image represents a state before the tread, what has been said above for the first movement direction also applies to the second movement direction (respectively the representation in the images). On the other hand, if the second image shows (substantially) the time point of the tread, the movement direction of the foot changes significantly, i.e. the second movement direction differs from the first movement direction. This is exploited in block 547 by ascertaining the tread of the user B onto the treadmill surface 22, if an angle between the first movement direction and the second movement direction exceeds a predetermined angle threshold value. This angle may preferably be at least 45°, at least 90° or at least 135°. Most preferably, the angle is between 160° and 180°. Information characteristic for the tread (for example, the tread location and/or the point in time of the tread) may be provided and/or output in block 549 for executing the control function. For this purpose, the angle does not necessarily have to be determined or compared with the angle threshold value. Rather, the control device 50 may, for example, recognize that this criterion is fulfilled if a Y coordinate of the image object changes (for example reduces) from the first image to the second image in a different direction than from the second image to the third image (wherein the Y coordinate increases again in the latter case).

FIG. 5 shows the mode of operation of the foot orientation detection device 56 of the control device 50 as a block diagram. The foot recognition from blocks 541 and 543 is also applied here, so that block 561 corresponds to block 541 and block 563 corresponds to block 543. In the next block 565, the foot orientation detection device 56 determines, in the second image, a minimum bounding rectangle for the image object and, in block 567, information about an orientation of this rectangle (more general polygon) relative to a reference direction of the treadmill, in particular the longitudinal direction of the treadmill surface. This may include determining a main extension direction (longitudinal direction) of the minimum bounding rectangle and an intermediate angle between the main extension direction and the longitudinal direction L of the treadmill surface. In block 569, the information about the orientation and/or the main extension direction may then be provided and/or output as part of the movement information for executing the control function.

FIG. 6 shows the mode of operation of the user recognition device 58 of the control device 50 as a block diagram. The foot recognition from blocks 541 and 543 is also used here, so that block 581 corresponds to block 541 and block 583 corresponds to block 543. In the subsequent block 585, the user recognition device 58 retrieves the contour points associated with the image object and preferably determines the user identity on the basis thereof and using data from a user database. It is noted that the term user identity does not necessarily allow conclusions to be drawn about the person using the treadmill 20 (for example, if different users carry the same shoes using the treadmill 20) and also do not have to be allowed. Instead, for example, the recognition of user No. 1, No. 2, etc. is sufficient. Subsequently, in block 587, the user identity may be provided and/or output as part of the movement information for the execution of the control function. For example, the same usage profile (e.g. a running environment or a yoga environment) may be selected on the basis of the recognized user identity (in particular of the shoes) even in the case of different persons. In other words, for example, the running environment may be displayed when a user identity corresponding to a runner profile has been detected and/or the yoga environment may be displayed when a user identity corresponding to a yogi/yogini has been detected.

In the variant described above, blocks 541, 543 and 561, 563 and 581, 583, respectively, are described as part of the tread determining device, foot orientation detection device 56 and user recognition device 58, respectively. Without limiting the generality, on the other hand, these common functional parts may be provided logically connected upstream and outside of said devices. The speed determining device 52, the tread determining device 54, the foot orientation detection device 56 and the user recognition device 58 may be integrated in the control device 50 in such a way that these devices are to be only logically understood as functional elements, but do not necessarily have to be implemented in separate physical elements of the control device 50.

A further variant of a treadmill system 10 shown in FIG. 7 differs from the treadmill system 10 of FIG. 1 in that none of the optical markers (first optical markers 30, second optical markers 32, third optical markers 34) are formed on the treadmill surface 22. Accordingly, the speed determining device 52, which is based on the presence of the optical markers, is missing in this treadmill system 10. Otherwise, the treadmill system 10 of FIG. 7 corresponds to the treadmill system 10 of FIG. 1.

A further treadmill system 10 shown in FIG. 8 differs from the treadmill system 10 of FIG. 1 in that it additionally has a display device 70 and the control function comprises controlling the display device 70 to display the (item(s) of) movement information. In addition, a memory 90 for storing the (item(s) of) movement information and/or a communication unit 92 for sending the (item(s) of) movement information are provided.

The display device 70 has a projection device (so-called projector) which is arranged to project the movement information determined as described above onto the part 24 of the treadmill surface 22. As shown in FIG. 8, the projection device projects a display image 72 into a partial region (so-called projection area) of the part 24 of the treadmill surface 22 registered with the detection region of the camera device 40 and, thus, to a part of the running surface of the treadmill 20 (stationary in the reference system of the surrounding). In order not to perturb the functionality of the camera device 40 and the control device 50 despite this overlap between the detection region and the projection area, the camera device 40 and the projection device of the display device 70 operate with electromagnetic radiation of different spectral ranges, namely the camera 40 with infrared radiation and the display device 70 with visible light. The camera 42 is correspondingly provided with an optical filter arranged on an optical axis of the camera 42 attenuating visible light by at least 80% or at least 50% (that is for visible light impermeable).

In this variant, as shown in FIG. 8, the arrangement of the optical markers corresponds to the arrangement of the optical markers at the treadmill 20 of FIG. 1. In a modification of the treadmill system 10 shown in FIG. 9a, the markers may only differ by their length parallel to the longitudinal direction, but not by their shape. In the variant of FIG. 9a, all the first, second and third markers 30, 32, 34 are therefore rectangular. The first markers 30 are of the same size and the second markers 32 are likewise of the same size, wherein the first markers 30 are each smaller than the second markers 32. The third markers 34 are not provided and the tracks 31, 32 are arranged in a line-symmetrical manner with respect to a central longitudinal axis of the running surface, wherein the first tracks 31 are arranged on the outermost lateral edge of the treadmill 20. In addition, a single-colored central strip 37 is formed on the treadmill surface 22, which strip 37 may serve as a background for the feet of the user B. The central strip 37 is preferably at least 20 cm, at least 30 cm, at least 40 cm or at least 50 cm wide and preferably extends parallel to the longitudinal direction L of the treadmill 20. The following applies: The wider the central strip 37 is, the more lateral foot movement freedom is made available to the user without impairing the foot recognition.

In a further modification of the treadmill system 10 of FIG. 9b based on the modification of FIG. 9a, it is provided that, on both sides of the central strip 37, two respective first markers 30 are configured as reference markers 60, 62 and 64, 66. These reference markers 60, 62, 64, 66 contain a pattern which is specific for the respective reference marker 60, 62, 64, 66. The reference markers 60, 62, 64, 66 thus differ from one another and from all other optical markers on the treadmill 20. The reference markers 60, 62, 64, 66 are arranged at corners of an imaginary rectangle on the treadmill surface 22. The camera device is configured for perspectively equalizing the plurality of images of the temporal image sequence on the basis of the reference markers 60, 62, 64, 66, such that regions corresponding to the first and second tracks 31, 33 in the images of the image sequence extend parallel to one another in the images of the image sequence.

In two further modifications of treadmill systems 10 of FIGS. 10a and 10b based on the modification of FIG. 9a, one and a plurality of third track(s) 35, respectively, as well as fourth track(s) 36 are provided, which extend parallel to one another, but transversely to the first and second tracks 31, 33. The treadmills 20 of these two treadmill systems 10 are preferably omnidirectional treadmills 20. In the modification of FIG. 10b, the first, second, third and fourth tracks 31, 33, 35, 36 are each grouped to a track group 39 having the shape of a segment of a circle. On the treadmill surface 22, a plurality of such circle-segment-shaped track groups 39 are joined in order to form together a circle with optical markers.

The functionality of the display device 70 of the treadmill system 10 of FIG. 8 is described below with reference to FIGS. 8, 11 and 12. Since the treadmill systems 10 according to the modifications of FIGS. 9a to 10b have all the features of the treadmill system 10 of FIG. 8, the following description also applies to said modifications.

The display device 70 serves for visual feedback of the determined movement information and may aim at inciting the user B to adapt his movement flows in a particular manner. For this purpose, the control device 50 may contain a display controller 59 in which the control function is executed. The control function includes forming the respective display images as follows. With regard to the locomotion speed of the user, presently, a virtual running environment with obstacles on the ground displayed by the display images is moved over the projection area according to the locomotion speed, that is synchronized with the movement of the treadmill surface 22. In block 591, the locomotion speed is obtained for this purpose. In block 592, the locomotion speed is used to synchronize a locomotion speed of the virtual environment/obstacle over the projection area with the movement of the treadmill surface 22. Finally, in block 593, the resulting display image is output to the display device 70 in order to be displayed.

On the basis of the main extension direction of the minimum bounding polygon/rectangle, control of the movement direction through the virtual running environment is realized. For this purpose, the corresponding movement information is obtained in a block 594 as explained above. In block 595, the virtual movement of the user is controlled in order to output the resulting display image to the projection device in block 596. In a similar manner, the position of the contour of the image object corresponding to the foot is taken over into the display image. To this end, block 597 provides for obtaining the corresponding data; block 598 realizes the insertion of the image object into the display image at the same location as in the second image; and block 599 again provides for outputting the resulting display image to the projection device.

In block 601, with regard to the step detection, the movement information of the tread determining device 54 is obtained. In this context, a separate initialization may take place in block 600. Subsequently, it is provided in block 602 that a collision event with a virtual object is determined. In block 603, the display image resulting therefrom is output to the projection device in order to be displayed. In this case, the display image may contain a superposition of the image object with the obstacle and optionally additionally a separate graphic as an indication of the collision (for example an exclamation mark). The display controller 59 then provides, in block 610, to control the display device 70 to display the display image.

In a further treadmill system 10 shown schematically in FIG. 13, the display device 70 is designed with VR glasses instead of the projection device. What has been said above for the projection device applies analogously to the VR glasses. Moreover, the treadmill system 10 of FIG. 13 contains all the features of the treadmill system 10 of FIG. 8. In particular, virtual feet may also appear in the 3D world at the sites at which the feet have been determined, so that the user does not fall from the treadmill, if he/she would be torn from the immersion due to lacking the feet.

A further treadmill system 10, the treadmill 20 of which is configured as a lamella-based treadmill (so-called lamella treadmill) and is shown in FIGS. 14a-d and 15a-b in a central longitudinal sectional view, differs from the treadmill system 10 of FIG. 8 in that the treadmill surface 22 is an upper side of a mat 80 which may be mounted to lamellae 26 of the treadmill 20 by means of a mounting device 82 fixedly connected to the mat 80 and may be non-destructively reversibly removed from the treadmill 20 when required (for example for washing or completely replacing the mat 80). This mat 80 having the mounting device 82 makes it possible to put together the treadmill system 10 comparably easily from a kit (not shown separately).

The mat 80 is designed here by way of example as a textile mat, in particular, a carpet (simplified “infrared running carpet”). On an underside opposite the treadmill surface 22, the mat 80 is adhered to two angle strips 95, 96 at one of its short edges 94. Each of the two angle strips 95, 96 may be hooked in the lamella-based treadmill 20 below a particular lamella 26, respectively, so that by forward movement of the treadmill 20 the mat 80 pulls uniformly and straightly over the treadmill 20.

The material of the mat 80 between the two angular strips 95, 96 is longer than a distance between the two particular lamellae 26. This causes the mat 80 to make a small fold 97 when the two particular lamellae are at a 90° angle to the user B. However, the deflection of the mat 80 over the deflection rollers is improved because a distance between the lamellae 26 is increased. The fold 97 forms buffer material which is required in order for the mat 80 (the carpet) not to be tensioned by the briefly increasing lamella spacing at the longitudinal edges of the treadmill 20 which would thus interfere with the running of the treadmill 20.

For the fold 97 being the least possible disturbing for the user B, the material of the mat 80 may be thinner and/or more elastic at the location of the fold 97 than at the rest of the mat 80. In addition, as shown in FIGS. 15a and 15b, a weighting magnet rail 98 may be adhesively bonded to the inner side of the bend of the fold 97, which magnetic rail 98 brings the fold 97 to the lamella 26 first due to gravity and additionally by magnetic force by means of a counter magnet 99. The magnet rail 98 and the magnet 99 may be adapted in terms of the size to the treadmill type and lamella spacing, so that a magnetic connection between them is sufficiently easily released during the deflection process. With correspondingly shortened but sufficiently elastic material, wrinkling may be avoided.

The mat 80 itself is preferably composed of two different layers, namely a lower layer (“basis”), which is formed as a rubberized anti-slip web structure (like a table-cloth base), and an upper layer (“top ply”) which is adhesively bonded to the lower layer and is formed from a material which may be freely selected (within the scope of reduced noise development and necessary bending capability), by means of which different running experiences are simulated or different projection effects are achieved. For example, at barefoot operation, a rough upper layer may act as massaging to the feet, while a rubber-like upper layer establishes a softer treading experience. If the treading experience is not in focus, but rather the quality of the optical projection, a respective well-projecting canvas material may be used as the upper layer.

In addition to an increased experience in the case of barefoot operation or projection as well as the possibility of changing the running surface in the event of soiling (and thus protecting the treadmill itself from soiling), the exchangeable running surface of the mat 80 may, in particular, enable detecting the feet by means of the infrared camera technically disturbance-freely. For this purpose, the markers described above are sprayed onto the upper layer and may be used for the camera as a type of code for measuring the speed of the belt as a reference.

Moreover, the treadmill system 10 of FIGS. 14a-d and 15a-b contains all the features of the treadmill system 10 of FIG. 8.

The terms “comprising”, “having”, “with” and the like used in this disclosure are to be understood as not limiting. In particular, the term “comprising a” means in this context “comprising at least a”, i.e., “comprising a” does not exclude the presence of further corresponding elements. In the present case, at least a/one means one or more. That is, the control device may determine one or more (items of) movement information, for example. For reasons of readability, the expression “at least” is partly omitted in this disclosure to simplify. If a feature of the present disclosure is described in the singular or indefinite, the plurality thereof should also be disclosed at the same time. At least in sections/in parts, it is to be understood as in sections/in parts or completely.

1. A treadmill system, comprising
a treadmill having a treadmill surface provided for treading on by a user, wherein optical markers are formed on the treadmill surface,
a camera device having at least one camera, wherein the camera device is configured for acquiring a temporal image sequence comprising a plurality of images of at least a part of the treadmill surface while capturing the markers, and
a control device configured for
receiving the image sequence from the camera device,
determining, based on the image sequence, at least a movement information of the user locomoting on the treadmill while treading on the treadmill surface, and
executing a control function based on the movement information.

2. The treadmill system according to claim 1,
wherein the markers are configured as infrared markers and the camera is configured as infrared camera,
and/or wherein the camera device further comprises an infrared light arranged for irradiating at least the part of the treadmill surface.

3. The treadmill system according to claim 1,
wherein the markers are arranged such as to form at least a first track and a second track,
wherein the markers of the first track and/or of the second track are arranged periodically on the treadmill surface, respectively.

4. The treadmill system according to claim 3,
wherein markers of the first track are arranged closer to each other and/or designed differently than markers of the second track,
and/or wherein the first track extends parallel to the second track,
and/or wherein the first track and/or the second track extend straight at least in sections,
and/or wherein the markers are arranged such as to further form a third track, which extends transversely to the first track and/or the second track.

5. The treadmill system according to claim 1,
wherein the markers comprise a plurality of, preferably at least 4, differently configured reference markers which are arranged at corners of an imaginary polygon on the tread-mill surface,
wherein the plurality of images of the temporal image sequence are subjected to an image correction, in particular are perspectively equalized, by means of the camera device on the basis of the reference markers.

6. The treadmill system according to claim 1,
wherein a single-colored central strip is formed on the treadmill surface,
wherein the strip preferably extends in a longitudinal direction of the treadmill.

7. The treadmill system according to claim 1,
wherein the movement information comprises a locomotion speed of the user on the treadmill surface, a position and/or a time of a tread of the user onto the treadmill surface and/or an orientation of a foot of the user at the time of the tread.

8. The treadmill system according to claim 1,
wherein the control device comprises a speed determining device which is configured for determining from the image sequence at least one temporal intensity profile at a predetermined location in the plurality of images and to determine, based on the at least one intensity profile, the locomotion speed of the user as part of the movement information.

9. The treadmill system according to claim 1,
wherein the control device is configured for determining, in at least a first image, a second image and a third image of the plurality of images, respectively, an image object having the largest area and/or contour.

10. The treadmill system according to claim 9,
wherein the control device comprises a tread determining device configured for:
determining a first movement direction of the foot of the user based on a first position of the image object in the first image and a second position of the image object in the second image,
determining a second movement direction of the foot of the user on the basis of the second position of the image object in the second image and a third position of the image object in the third image, and,
if an angle between the first movement direction and the second movement direction exceeds a predetermined threshold value, ascertaining the tread of the user on the tread surface.

11. The treadmill system according to claim 10,
wherein the control device further comprises a foot orientation detection device configured for determining, in the second image, a minimum bounding polygon for the image object as well as a main extension direction of the minimum bounding polygon,
wherein the movement information comprises the main extension direction.

12. The treadmill system according to claim 1,
wherein the treadmill system further comprises a display device, and wherein the control function comprises controlling the display device to display the movement information.

13. The treadmill system according to claim 12,
wherein the display device comprises a projection device arranged to project the movement information onto the treadmill surface, in particular onto the part of the treadmill surface.

14. The treadmill system according to claim 12 or 13,
wherein the camera is provided with an optical filter attenuating visible light, wherein the optical filter is arranged on an optical axis of the camera.

15. The treadmill system according to claim 1,
wherein the treadmill surface is configured as a surface of a mat,
wherein the mat is provided with a mounting device by means of which the mat is non-destructively reversibly attachable to lamellae of the treadmill.

16. A kit for upgrading a treadmill to a treadmill system according to claim 15, comprising
the camera device,
the control device, as well as
the mat having the mounting device.
